(19) United States
(12) Patent Application Publication
(10) Pub. No.: US 2025/0271210 A1
(43) Pub. Date: Aug. 28, 2025

(54) LUNAR WATER EXTRACTOR

(71) Applicant: Argo Space Corp., Hermosa Beach, CA (US)

(72) Inventors: RYAN CARLISLE, Hermosa Beach, CA (US); KIRBY CARLISLE, Hermosa Beach, CA (US)

(73) Assignee: Argo Space Corp., Hermosa Beach, CA (US)

(21) Appl. No.: 18/588,725

(22) Filed: Feb. 27, 2024

(51) Int. Cl. F26B 3/28; B64G 4/00; F24S 20/30; F24S 50/20; F26B 9/08

(52) U.S. Cl. CPC F26B 3/286; B64G 4/00; F24S 20/30; F24S 50/20; F26B 9/082

(57) ABSTRACT

A water extraction system including: a base; and an extraction system, the extraction system including: a heated chamber, the heated chamber including an outer annulus and an inner core; a solar reflector; an auger contained within the outer annulus; and a water vapor collection system, wherein the system is configured for feeding regolith from an input bin to an inlet of the heated chamber, wherein the auger is configured to move the regolith along the outer annulus of the heated chamber to a top part of the heated chamber and recycle heated regolith to the inner core, wherein the solar reflector is configured to heat the heated chamber using concentrated solar energy, wherein the heated chamber is configured to liberate water vapor from the regolith, wherein the water vapor collection system is configured to collect the water vapor.

### TECHNICAL FIELD

Embodiments of the disclosure relate to space technology, namely to systems, methods, and devices for collecting water from extraterrestrial substrate, such as regolith, frozen pieces of ice, etc. The disclosed subject matter relates to extracting water from regolith on the lunar surface for use as a propellant or for lunar stations.

### BACKGROUND

Systems for extracting water from regolith are known. However, known systems are limited in capability, efficiency, and commercial viability. For example, some known systems are typically limited to extracting lunar water from high water concentration substrates, such as ice bearing regolith found in permanently shadowed regions (PSRs).

Lunar water harvesting development has primarily focused on PSRs with high water ice concentrations (>2%) of regolith. PSR mining designs are designed to require power beaming or long power lines due to lack of sunlight, transit in and out of craters, and to be capable of handling the expected high strength and hardness of high ice concentration PSR regolith. These complexities require delivery of large mass to the lunar surface before any utility can be realized.

### SUMMARY

Embodiments of the disclosure include a water extraction system to allow commercially viable harvesting at small and large scale. The system may include surface mobility vehicles with collection systems for bulk regolith collection. The collected bulk regolith may be deposited in a water extractor. The water extractor may include an extraction tower. The extraction tower may rely on sunlight exclusively or a combination of sunlight and stored energy, such as from a battery or other energy storage device. The sunlight may be concentrated. The sunlight may be concentrated by any known sunlight concentration system. A sunlight concentration system may include reflectors, such as parabolic mirrors. The concentrated sunlight may heat the regolith and separate water vapor, such as by sublimation of ice or boiling or evaporation of liquid water. The separated water vapor may be collected, such as in a cold trap. The collected water or water-derived products such as oxygen may be used locally, such as for lunar stations or for processing into propellant, such as oxygen, hydrogen, or H₂O₂. The collected water or water-derived products may also be exported, such as to orbital depot locations.

Embodiments of the disclosure include a sealable closed system for processing frozen regolith using concentrated solar heat with a parabolic reflector to sublimate water ice to vapor as regolith passes through a cylindrical annulus with a rotating auger, trapping the water vapor by re-freezing it downstream with a cold trap.

Embodiments of the disclosure include a deployable parabolic reflector trough for concentrating solar heat. The parabolic reflector may include a dust rejection mechanism, such as an integrated electrical or vibratory dust rejection mechanism.

Embodiments of the disclosure include a cylindrical annulus with a rotating auger that receives concentrated solar heat and an inner core that collects heated regolith to recycle the absorbed thermal energy towards heating incoming frozen regolith.

Embodiments of the disclosure may include a sealed output bin, such as an automated vacuum sealing output bin for dry regolith.

Embodiments of the disclosure include a method for extracting water from Lunar regolith that contains water ice. The method of extracting water may be from Lunar regolith containing low concentrations (e.g., <2%) of water ice. The method may include concentrated sunlight.

Embodiments of the disclosure may reduce or minimize the power generation required to extract water from regolith by applying concentrated solar energy directly to the regolith extraction system during processing.

In an embodiment, the system may autonomously close mechanical vacuum seals, such as between the input bin, such as a hopper, and the heated chamber, and between an output bin, such as a hopper, and the heated chamber. Once sealed, the auger may start rotating to pull ice-containing regolith from the input bin through a heated chamber. As the regolith is heated in the heated chamber, water ice sublimates into vapor and expands within the system to flow to and re-freeze in a cold trap. The heated dry regolith byproduct collects in an inner core until the complete batch of regolith has moved through the system. An output bin seal may open and allow the dried regolith to fall into an output bin or back onto the surface of the moon. The next batch of frozen regolith may be added to the input bin to repeat the process.

In an embodiment, the system relates to mass- and power-efficient collection and extraction of low-concentration water (such as ≤15000 ppm, ≤10000 ppm, ≤5000 ppm, ≤ 1000 ppm, or ≤500 ppm, such as 10 to 15000 ppm, 10 to 10000 ppm, or 100 to 5000 ppm) from bulk lunar regolith, typically outside of PSRS.

Embodiments of the disclosed system may enable extraction of low-concentration water from bulk regolith outside of PSRs with low surface mass and low energy requirements. Embodiments provide flexibility, modularity, and scalability, with the ability to start operations with a single extractor and add units to match demand.

Embodiments of the disclosed system may enable use of Lunar resources with a commercially viable system, such as high rate, low surface mass, without major surface infrastructure as a prerequisite. Embodiments can avoid the need for complex, costly solutions, and high-risk operations in PSR conditions. Embodiments can enable wide operating area, mitigating contested/congested surface operations. By relying on, for example, concentrated solar energy and heated regolith recycling, embodiments may reduce downmass and energy generation needed to extract water. Embodiments are robust in that regolith with a varied concentration of water may be utilized; at least certain embodiments do not require a certain minimum or maximum of water concentration.

Embodiments of the disclosed system can efficiently process low concentrations of icy regolith with far less electrical power and mass than known alternatives. In embodiments, the water extraction system can function with minimal photovoltaics, such as photovoltaics to power avionics and motors to move regolith and track the sun.

### BRIEF DESCRIPTION OF THE FIGURES

FIG. 1 is an exemplary water extraction tower with an input bin and an output bin.

FIGS. 2A-2C show exemplary cross sections of the water extraction tower.

FIG. 3 shows an exemplary water extraction tower with parabolic mirror in isometric view

FIG. 4 shows an exemplary water extraction tower showing movement of regolith at three different times.

FIG. 5 shows exemplary demand for generated power for water extraction.

### DETAILED DESCRIPTION

Various examples and embodiments of the inventive subject matter disclosed here are possible and will be apparent to a person of ordinary skill in the art, given the benefit of this disclosure. In this disclosure reference to “embodiment” and similar phrases each means that those embodiments are non-limiting examples of the inventive subject matter, and there may be alternative embodiments which are not excluded.

The articles “a,” “an,” and “the” are used herein to refer to one or more than one (i.e., to at least one) of the grammatical object of the article. By way of example, “an element” means one element or more than one element.

As used herein, the term “about” means ±10% of the noted value. By way of example only, an angle of 180° could include from 162° up to and including 198°.

The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

The different aspects, alternatives and embodiments of the invention disclosed herein can be combined with one or more of the other aspects, alternatives and embodiments described herein. Two or more aspects can be combined.

Specific embodiments of the disclosure will now be described with reference to the accompanying drawings. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. The terminology used in the detailed description of the embodiments illustrated in the accompanying drawings is not intended to be limiting. In the drawings, like numbers refer to like elements.

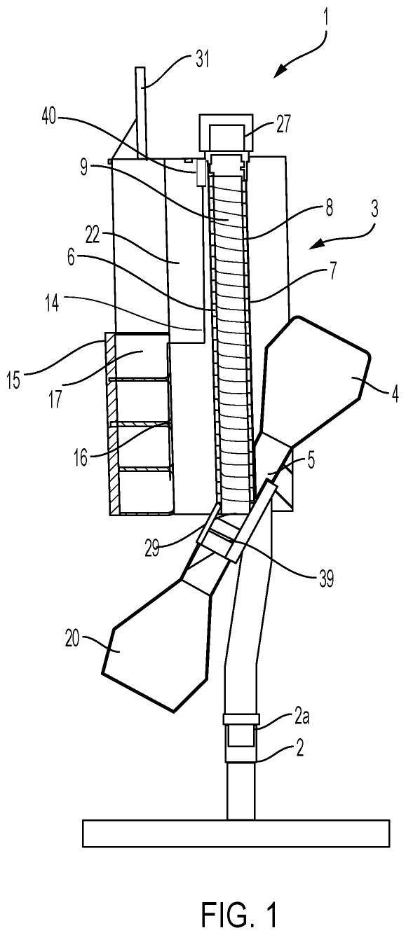

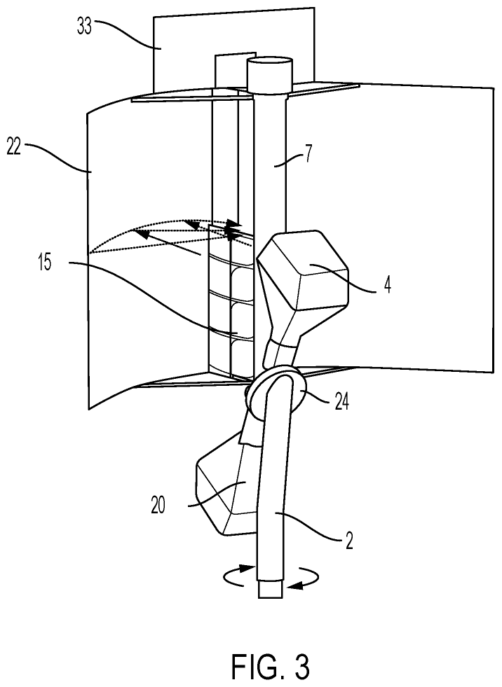

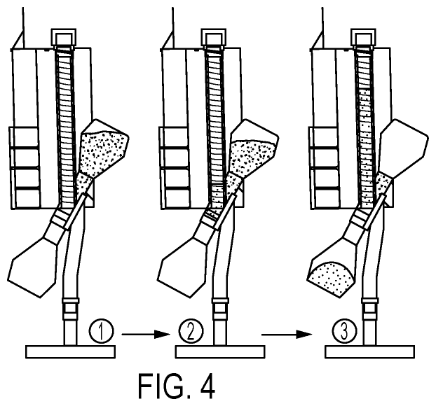

Embodiments of the disclosure include a water extraction system 1 as shown in FIGS. 1-4. The system 1 may be in the form of a tower and may include a base 2. On the base is a system 3 for extracting water from icy regolith.

In an embodiment, the base may be configured to rotate the system. For example, the base may be configured to rotate the system from 90-360°, for example, 180-360°, for example about 350°. An advantage of having the base rotate the system is that the system may be rotated to follow the sun. This may avoid the need to have a solar reflector 22 rotate relative to a heated chamber 7.

The base may rotate by means of a base motor 2a, which may be positioned internally or externally on the base 2.

The base may hold the system 3 at a 1-10°, such as about 2.5°, tilt normal to a low polar sun altitude on the lunar surface.

The base 2 may be constructed from high performance plastics, composites, or metals such as aluminum alloy, stainless steel, or titanium. The length of the base, from lunar surface to the bottom of the heated chamber may be 10-200 cm.

The base may be configured to securely anchor the extractor system to the lunar surface by extending below the surface via screw anchors or driven poles, or it may sit on top of the surface and provide support via a baseplate, cables, or other securing system.

The base motor may be sized to provide sufficient torque and speed to slew the entire assembly to track the sun over the course of a lunar day via gearing or other motor reduction system. The motor may be controlled by an electronic control system to ensure accurate tracking.

The system 3 may be sealed, particularly when in operation. The system may be sealed by metallic, polymer, or spring-energized seals and sealing systems. These seals may serve to retain liberated water vapor and other volatiles. The sealing systems may operate across a wide temperature range.

The system 3 may include an input bin 4 which can hold fresh icy regolith. The input bin 4 is configured to feed an inlet port 5 of the system 3. In an embodiment, the feed is primarily gravity fed. For example, the input bin 4 may have an end raised above the inlet port 5. In an alternate embodiment, the feed may be fed by a rotary valve or similar method to drive flow of the feed regolith into the heated chamber.

The input bin may be sized to provide a quantity of regolith to the heated chamber either in batch or continuous operating modes. The input bin may be round, cylindrical, or prismatic in shape, providing internal surfaces configured to promote flow into the heated chamber. The input bin may be made of metals such as aluminum alloys, stainless steel, or titanium. The system may be designed to allow for a variety of input bin sizes, ranging from tens to hundreds of kilograms of regolith capacity.

The input bin may be filled by a regolith collection system on a rover or other regolith harvesting apparatus. The bin, full of water-bearing regolith, may be mated to the system 3, near the base, by a rover or other collection system. This may include first removing a previous bin full of dried regolith. The bin of ice-bearing regolith may then be moved via rotation into the input location, while the previous input bin, empty after completion of a processing cycle, may move to the output location. This movement may be accomplished via the use of a rotational or slewing mechanism.

The heated chamber 7 includes an outer annulus 8 and an inner core 9. In an embodiment, the heated chamber is generally cylindrical.

In the heated chamber is an auger 6. The auger 6 is configured to move the regolith vertically along the outer annulus 8 of the heated chamber 7. In an embodiment, the auger 6 is rotated by a motor located in the top part. A box 27 may house the motor, electronics, and other control features. When rotated, the auger 6 collects icy regolith at the inlet of the heated chamber 7. As the auger 6 rotates, the regolith is vertically moved up the outer annulus 8. At the top end of the auger 6, the icy regolith has been heated and water vapor has sublimated and/or evaporated, depending on temperature and pressure internal to the chamber, from the regolith. The regolith is now desiccated, having on the order of 70-99% of its water liberated into vapor, and heated by tens up to hundreds of degrees kelvin above the input temperature. For example, the dry, heated regolith may now have a water content of 0-100 ppm and be at temperature of 50-150° C. A top end of the auger 6 may move the heated regolith from the outer annulus to the inner core 9. The top end of the auger 6 may be located at a top part of the heated chamber. For example, the top end of the auger may be located in the top 20% of the height of the heated chamber, such as in the top 10%.

The auger motor may connect to the auger 6 by known connections, such as a shaft and spokes.

Once the heated regolith has moved over to the inner core 9, the heated regolith may then fall, by gravity, down the inner core 9. The inner core may include baffles or a spiral to control the fall of the heated regolith. At this point, the heated regolith may recycle heat to the auger, the outer annulus, and specifically to any icy regolith in the outer annulus. Vanes, strakes, baffles, or other structures may be contained in the inner core to facilitate heat transfer from the heated regolith to the outer annulus. These structures may be made from a thermally conductive metal such as aluminum alloys or copper alloys to improve heat transfer. The heated regolith provides efficient and effective use of the heat initially added to the system to provide for improved water vapor collection per mass of the system.

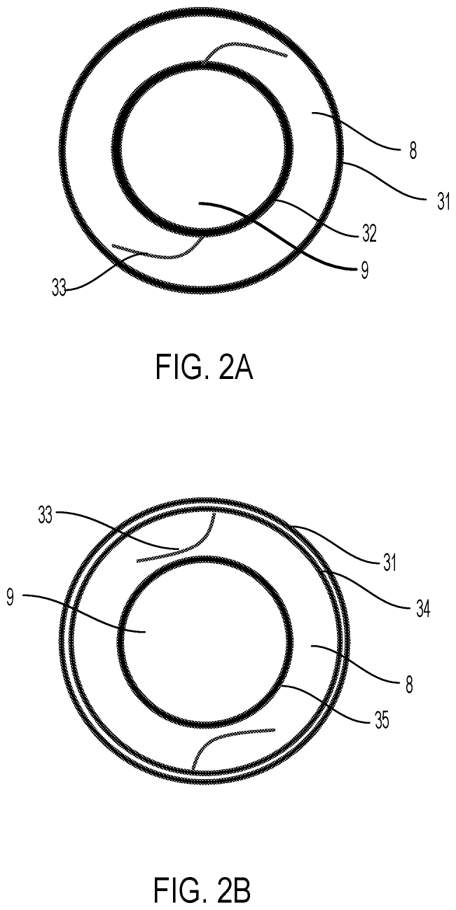

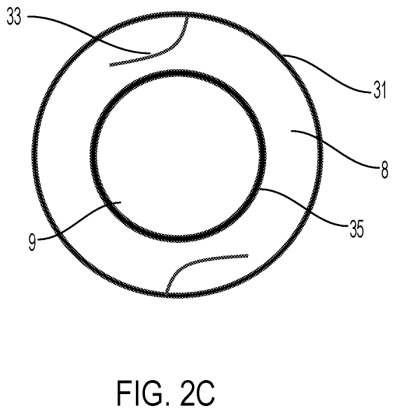

The inner core 9 may be provided by a central core of the auger 6. The outer annulus 8 and inner core 9 may be generally separated by the auger 6, and optionally, a cylindrical wall. The outer annulus 8 and inner core 9 may be separated to keep heated regolith separated from icy regolith. That is, the auger 6 may be a hollow core auger, with spiral blades attached to the outer wall of the hollow core. The cross-sectional view of FIG. 2A shows an embodiment of a cross-section approximately midway up the heated chamber. In an alternative embodiment, as shown in FIG. 2B, the auger may be arranged such that the spiral blades are arranged on an inner wall that is near an inner wall of the outer annulus. In this arrangement, a cylindrical wall separates the auger from the inner core 9. In an alternative embodiment, as shown in FIG. 2C, the auger may be arranged such that the spiral blades are arranged on an inner side of the outer annulus. In this arrangement, a cylindrical wall separates the auger from the inner core 9.

FIG. 2A shows an outer wall 31 of the heated chamber, an outer annulus 8, the wall 32 of a hollow shafted auger, with the spiraling blades 33 of the auger connected to the wall 32, and the inner core 9.

FIG. 2B shows an outer wall 31 of the heated chamber, the wall 34 of a hollow shafted auger, with the spiraling blades 33 of the auger connected to the wall 34, an outer annulus 8, a dividing wall 35, and the inner core 9.

FIG. 2C shows an outer wall 31 of the heated chamber, the outer wall being the wall of a hollow shafted auger, with the spiraling blades 33 of the auger connected to the inner side of the outer wall 31, an outer annulus 8, a dividing wall 35, and the inner core 9.

The heated chamber 7 may be a cylindrical structure made of metal such as aluminum alloy, stainless steel, or titanium. The chamber may be painted, coated, or similarly surface treated to effectively absorb thermal energy from sunlight. The heated chamber may have an outer diameter in the range of 100-500 mm, such as approximately 200 mm. The chamber may have a height in the range of 1000-5000 mm, such as approximately 2000 mm. The chamber outer wall may have a thickness within the range of 0.3-5 mm, such as approximately 1 mm. The outer wall of the heated chamber forms the outer wall of the outer annulus and auger. Within the outer annulus is the auger, which wraps around the inner wall of the outer annulus. The auger may be a spiral surface composed of metal such as aluminum alloys, stainless steel, or titanium. The auger surface may be in the range of 0.3-3 mm thick, such as 1 mm thick, and make between 5 and 20 turns per meter of height, such as approximately 10 turns per meter.

An inner surface of the outer annulus 8 may include an outer surface of the inner core 9. For example, the auger 6 may act as the inner surface of the outer annulus 8 the outer surface of the inner core 9. The inner core 9 may be a cylindrical chamber composed of metal, such as aluminum alloy, stainless steel, copper alloy, or titanium. The outer surface of the inner core 9, such as the wall 32 or the auger 6, transfers heat from the internal, previously heated regolith to the new icy regolith in the outer annulus 8. The inner core 9 may have a diameter in the range of 100-300 mm, such as 120-200 mm, such as approximately 160 mm. The wall 32 of the inner core may have a thickness in the range of 0.3-3 mm thick, such as approximately 1 mm thick.

The heated chamber 7 is heated by concentrating solar energy. Solar energy may be concentrated by a solar reflector 22 or optical (e.g., prisms, lenses etc.) concentration means. In an embodiment, the solar reflector 22 may be a parabolic reflector or a segmented reflector.

The solar reflector 22 may be collapsible, particularly for transport, launch, packaging, and thermal insulation. The solar reflector 22 may collapse and expand via cable, motor, linear actuator, strain-based, or spring-loaded actuation.

The solar reflector 22 may include a dust rejection mechanism, such as an electrostatic or vibratory dust rejection or prevention apparatus. This mechanism may serve to keep the reflecting surface of the mirror substantially free from dust that would impede performance.

In an embodiment, the heated chamber 7 is only heated by the solar reflector 22. By heated only by the solar reflector, this means that in excess of 95% of the total heat provided to the regolith is provided by the solar reflector. The other heat may be incidental heat from the auger motor, friction from rotation of the auger, waste heat from electronics, or incident sunlight or radiation not collected by the reflector.

The solar reflector may be composed of a thin sheet of aluminized mylar, or other lightweight highly reflective material, suspended between or over a structural frame. The structural frame may be composed of high performance plastics, composites, or metals such as aluminum alloys, stainless steel, or titanium. The frame may provide the shape and deployment kinematics for the solar reflector. The frame may be composed of static structural elements as well as various hinges, joints, and mechanisms such as latches to complete the deployment and securing of the solar reflector. The solar reflector may fold to a protective position to provide thermal insulation to the extractor system during the lunar night.

Water vapor sublimates from the regolith during heating in the outer annulus 8 (and to a smaller degree from the already-heated regolith in the inner core 9). The water vapor expands and rises to a top part of the heated chamber 7. There, the water vapor may pass through a line 14 to an water vapor collection system 15. The water vapor collection system is configured to collect the sublimated water vapor. In an embodiment the water vapor collection system 15 collects the water vapor in a cold trap 16. The cold trap may be configured to hold 5-50 kg of ice, generally enough from tens to a few hundred input loads of icy regolith.

The cold trap 16 may include a cold plate and a method for heating to melt frozen H2O to fill a water storage chamber 17 for extraction. The cold trap may consist of a thermally conductive surface, such as a metallic plate or series of tubes, which are maintained at low temperature, such as below 0° C. by being shaded from sunlight. Water vapor freezes to solid ice upon coming into contact with the cold surface. Once sufficient ice has built up from a processing cycle, the cold trap may be heated by redirecting solar energy using the reflector. This heating may be accomplished by moving one or more sections of the mirror such that the reflect sunlight onto the cold trap rather than shading the cold trap. When heated, the ice melts to water and may be collected in an H2O storage vessel. The storage vessel may be a cylindrical container comprising a pressure vessel and a sealing system to prevent water loss to vacuum. The vessels may be removeable from the extractor assembly for transport or consumption by other processes. A valve 40 may separate the vessels from the cold trap and extraction system to facilitate removal without water loss.

In an embodiment, the heated regolith may collect in the inner core 9. Once a batch of regolith has been processed through the outer annulus 8, the inner core 9 may be emptied. The inner core may include an outlet 29 at the bottom of the inner core. The system may include a valve 39 to release the heated regolith. The released regolith may be deposited on the lunar surface, may be deposited in a collection device, such as a rover, or may be deposited in an output bin 20. The system may release the regolith based on processing completion or based on a temperature decision (e.g., the regolith has cooled to near ambient lunar temperature, such as within 30° C. of ambient lunar temperature, the regolith is within some degrees of regolith in the next batch, such as within 30° C. of the regolith in the next batch, or a predetermined some efficiency threshold, etc.).

An output bin 20 may collect the desiccated regolith at the lower end of the extractor tower. This output bin may be of the same configuration as an input bin, and may be swapped by a rover or other regolith harvesting and delivery apparatus, for use as an input bin for a subsequent batch.

A rotational joint, of which one embodiment is a slewing ring 24, may rotate the input and output bin locations as needed. The slewing ring may be driven by an electric motor and gear system and electronic control system. The bins may be attached to the slewing mechanism by one or more latching and sealing mechanisms.

In an embodiment, the water extraction system is configured to extract water from regolith containing <2 wt % water. For example, the icy regolith may contain ≤15000 ppm, ≤10000 ppm, ≤5000 ppm, ≤1000 ppm, or ≤500 ppm, such as 10 to 15000 ppm, 10 to 10000 ppm, or 100 to 5000 ppm. From the icy regolith, the water extractor may collect 70-99% of the water therein. For example, the released regolith may contain less than 5% of its original water.

In an embodiment, the system is configured for batch operation.

The batch operation may proceed according to the following steps.
Load 1 regolith is collected into an input bin.
Load 1 input bin is connected to the bottom area of the slewing assembly.
Load 1 input bin is rotated to the upper, input location by the slewing mechanism.
A valve is opened or actuated between the input bin and the outer heated chamber and auger.
Load 1 regolith is fed into the auger.
Load 1 regolith is transported vertically upward in the auger by rotation of the auger, during which it is heated by action of the solar collector.
The first part of load 1 reaches the top of the auger and drops into the inner core, having been heated and dried.
Load 1 collects in inner core (1^{st} part heating 2^{nd} part).
Heating and transport continues until the input bin is empty and all regolith has collected in the inner core.
A valve is opened between the inner core and the output bin.
Load 1 moved to output bin.
A new input bin, containing Load 2, is brought to the extractor tower for processing.
Load 2 bin is swapped with the now full output bin containing Load 1.
The slewing mechanism rotates to such that the now empty load 1 input bin and the load 2 bin change places, placing load 2 in the upper input area.

In an alternate embodiment, the system is configured for continuous operation, semi-continuous operation, or multi-batch operation, dependent on the system configuration, input and output bin size, and feed rate.

The continuous, semicontinuous or multi-batch operation may proceed according to the following steps.
Load 1 moved to input bin.
Load 1 fed by auger.
Load 1 collects in inner core.
While the latter portion of load 1 is in the auger, Load 2 is placed in the input location via the slewing mechanism or another apparatus
Load 2 fed by auger (Load 1 heating Load 2).
Load 1 slowly moved to output bin (to keep one load worth of material in inner core).
Load 3 moved to input bin.

In an embodiment of the disclosure, the tower may further include a PV solar panel, electronics, motors, etc. The solar panel may provide the electrical power for command and control, actuation, sensors, and other functions of the extractor system.

In an embodiment, the tower may include electrical systems and components such as processors, sensors, wiring harnesses, data handling and storage, and power distribution systems. These electrical systems may be responsible for control and actuation of the extractor system, valves, motors, and other functions.

In an embodiment, the extractor system may contain electrical communications equipment such as radios, modems, transmitter and receiver antennas, and signal processing equipment. This equipment may be used to communicate status, commands, and other information back and forth between the processing system and other related systems. These related systems may include spacecraft in lunar orbit, spacecraft in earth orbit, vehicles and rovers on the lunar surface, other extractor systems, or other systems on the lunar surface involved in the extraction, utilization, and storage of resources such as water. This communication equipment may also be used to transmit or receive data to and from humans on the lunar surface.

In an embodiment of the disclosure, the water extractor may have a mass of 50-500 kg, such as 95 kg.

Embodiments of the disclosure relate to a method for a method for extracting H2O from regolith in a water extraction tower. The regolith may be icy regolith with a water concentration of ≤15000 ppm, ≤10000 ppm, ≤5000 ppm, ≤1000 ppm, or ≤500 ppm, such as 10 to 15000 ppm, 10 to 10000 ppm, or 100 to 5000 ppm.

In an embodiment of the disclosure, the method may include feeding regolith from an input bin to an inlet of a heated chamber, the heated chamber including an outer annulus and an inner core. The method may further include providing regolith from an extraterrestrial surface, particularly a lunar surface. For example, a rover may be used to provide regolith to the input bin.

In an embodiment of the disclosure, the method may include heating the heated chamber with solar energy from a solar reflector. Temperatures achieved may be in the range of 50-200 degrees Celsius, as required to liberate water adequately from the icy regolith at sufficient rate.

In an embodiment of the disclosure, the method may include moving the regolith vertically through the outer annulus, wherein the regolith is heated such that water vapor is liberated from the regolith. The regolith may be moved vertically by a rotating auger. The auger may rotate faster or slower to vary the mass flow rate of the regolith, which may also be used to vary the temperature to which the regolith is heated. An embodiment of the system may operate in the range of 100-1000 kg of regolith processed per hour

In an embodiment of the disclosure, the method may include recycling the heated regolith to the inner core of the heated chamber, wherein the heated regolith transfers heat to regolith in the outer annulus.

In an embodiment of the disclosure, the method may include collecting the sublimated water vapor in an H2O storage chamber. The method may include collecting the sublimated water in a cold trap. In an embodiment, the cold trap may collect the sublimated water as ice. The method may further include melting the collected ice. The melted ice may be collected in a water storage chamber. Melting the collected ice may occur at a later time when there is a desire to extract water from the system.

In an embodiment of the disclosure, the method may operate with a sealed system, at least during water vapor extraction from the regolith.

In an embodiment of the disclosure, the method may include releasing the heated regolith. At the time of release, the heated regolith may have cooled to approximately ambient conditions.

In an embodiment of the disclosure, the heated regolith may be retained over the course of a lunar night in order to provide thermal energy to the electrical and other components of the extraction system that would otherwise be exposed to extremely cold temperatures.

In an embodiment of the disclosure, the method may further include releasing the heated regolith to an output bin. For example, the method may include holding the heated regolith in the inner core until input bin is empty. For example, the method may include holding the heated regolith in the inner core until input bin is at least 50% empty.

In an embodiment of the disclosure, the method may further include rotating a base of the water extraction tower. For example, the method may further include rotating the base to track the sun. For example, the method may further include rotating the base about 350°.

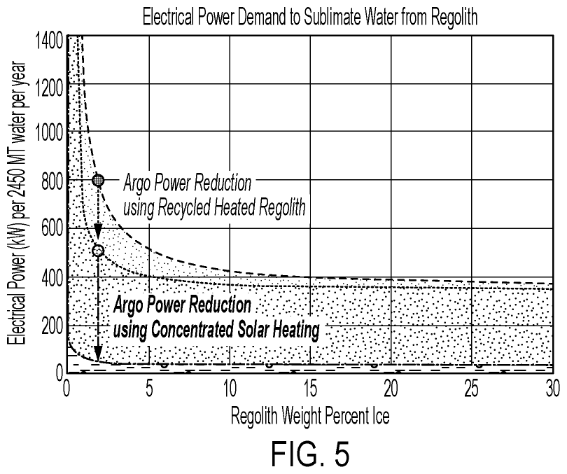

Embodiments of the disclosed regolith collection and water extraction system can provide high uptime without human intervention and efficient extraction of water outside PSRs. Non-PSR water extraction has not been a focus of the commercial or scientific community, at least in part because at below 2% water concentration the power requirement is dominated by heating the regolith rather than the ice therein. The amount electrical power demand to sublimate water from regolith as compared to the weight percentage of ice in the regolith is shown in the curves of FIG. 5. Embodiments of the disclosure enable a lowering of a traditional energy curve by combining; concentration of “free” solar energy using a solar reflector for regolith heating; and recycling of heated regolith, enabling mass- and power-efficient low concentration water harvesting in combination with only a small amount of electric power for, e.g., actuation, controls, and communications. The required electrical power may be generated with solar panels, such as lightweight, self-curing panels.

In an embodiment, a water extraction tower of 95 kg may produce 100 to 2000 kg, such as 400-1000 kg, such as about 615 kg of water annually from regolith containing 1,000 ppm ice. The power demand per gram H₂O may be 30-100 Wh/g, such as 45-75 Wh/g, such as about 57 Wh/g “free” concentrated reflective heating, 5-50 Wh/g, such as 15-40 Wh/g, such as about 26 Wh/g conserved heat from recycling heated regolith, and only 0.3-3 Wh, such as 0.5-1.5 Wh, such as about 0.8 Wh PV solar cell generated electrical power per 1 g H₂O.

Embodiments of the disclosure related to a water extractor and a separate regolith collector and removal system.

The system may include any bulk regolith collection system. For example, the system may include an unmanned rover with, e.g., RASSOR or IPEx-type bucket drums to gather regolith up to 1 m deep in polar regions. In an embodiment, an excavation drum may have a mass of 10-50 kg. The rover may collect the excavated regolith into a modular bin that can be delivered to a water extractor for processing. The system may have a processing rate of 50-500 kg, such as 100-300 kg, such as 210 kg of regolith per hour per extractor tower. The autonomous rover may interface with each tower by removing a lower bin full of dry regolith from a previous batch and replacing it with a bin full of icy regolith. The rover may then depart to empty the dry regolith bin and refill it with freshly excavated icy regolith. Emptying the dry regolith bins can be coordinated with building berms, roads, and other surface infrastructure to maximize multi-purpose objectives.

Once a fresh bin of icy regolith is mated to the extraction tower, a central slewing ring may rotate the empty upper bin down to the lower position, with the full icy bin moved up to the upper position for processing. The central vertical auger may rotate to lift grains of icy regolith from the upper bin and heat it to about 100° C. using concentrated sunlight reflected by the solar reflector. The contained water ice sublimates to vapor and may be collected in a cold trap, such as a shaded cold trap. Heated, dried regolith reaching the top of the auger may pass back down through an inner core, transferring its heat into the incoming cold icy regolith still in process, greatly increasing system efficiency. A rotary valve at the base of the inner core may rotate to regulate the movement of dry regolith into the output bin once its heat has been recycled, until all icy regolith has been processed.

A tower may tilt back 1-10°, such as about 1.5°, normal to the low polar sun altitude. A tower may also include a motor-actuated rotating base that slowly tracks the sun, rotating itself about 360° during each Lunar day, then rotating back to the starting position during each Lunar night. For example, a tower may transition to safe mode at night to retain heat and power.

In an embodiment, captured water may be transferred to a storage tank for sale, export, or further processing.

Benefits of embodiments of the disclosure may be measured by annual H2O extracted per landing mass and required electrical power per gram of H2O. These may be significant measures as landed mass and generated power as the scarce lunar resources. In an embodiment, for each kg of landed tower mass, a system can produce over 4 kg, such as over 10 kg, such as over 15 kg of water per year on the Lunar surface over the life of the extractor tower.

Benefits of embodiments of the disclosure also may be measured by amount of generated electrical energy on the lunar surface required to produce each kilogram of H2O. In an embodiment, a system can produce each kilogram of water using under 3 Wh, such as under 1 Wh of electrical power.

Additionally, embodiments of the disclosure aim to reduce complexity, in order to provide a robust system that can operate with minimal human interaction. For example, embodiments aim to provide simplified operations in non-PSR polar regions, autonomous regolith excavation and water extraction, low landing mass investment with immediate production capability, flexibility in location options for use, low electrical power required per gram H2O extracted, and portability & scalability enabled by self-supplied low power generation requirements.

In an embodiment of the disclosure, the regolith water extraction system may be scalable. For example, scaling can be accomplished simply by increasing the number of extractors delivered to the surface. As they can operate in any region with sufficient sunlight and their input feedstock may be provided by mobile rovers, multiple identical extractor towers can be placed in any desired location to increase total water generation rate. The low per-tower mass and compact packaging volume allow for simple quantity scaling to match downmass provider payload capability while avoiding large non-recurring engineering effort. The low tower mass is enabled by the extremely lightweight nature of the primary energy input, the solar collector mirrors. The packing volume of the tower system may be very compact, such as approximately 2 m×0.5 m×0.5 m, enabled by the nested cylindrical design of the auger and inner chamber, and the folding capability of the lightweight solar reflectors.

In an embodiment, total energy input may be directly proportional to an area of the solar reflectors. The solar reflectors may be extremely lightweight compared to competing energy sources and package compactly pre-deployment. Making use of the increased thermal energy is likewise mass efficient, requiring an increase in regolith transport rate through the vertical heating assembly rather than a purely proportional increase in physical system size.

In one embodiment, a tower design is sized for multiple to fit within the 2.5 m payload volume on Astrolab's FLEX rover or a similar rover system with a minimum of actuations and deployments.

In an embodiment, by roughly doubling the linear dimensions of the deployed systems for a 4 m tower, the water generation rate may be increased by nearly 4× while expected mass increases by only 2.2λ, resulting in 12 kg of H2O per kg of extractor mass: a 75% increase in water production efficiency over a baseline system on a mass per mass basis. Scaling down from the baseline results in lower specific generation rates, but the lightweight and robust system architecture still allows for useful quantities of water to be generated from very compact payloads. For example, a 20 kg 12U sized system, deployable from a range of rover concepts, could produce 4 kg of water per Lunar Day if operating with a steady supply of gathered regolith.

In an example, it is expected that a tower having a 1.9 m tall auger rotating at 7.5 rpm with spiral flights, can lift 15 kg of icy regolith every 4 minutes so that a 210 kg batch of icy regolith is processed in 55 minutes, with a 5 minute regolith bin swap to offload dry regolith, receive new icy regolith, and slew the empty upper bin down with the new full icy bin moving up to process the next batch.

This results in a regolith processing rate (\dot{m} reg) of about 210 kg/hr baselining assumptions of processing 1000 ppm regolith ice concentration (cp_reg) at a 67% extraction efficiency (eeff), resulting in 615 kg H2O extracted per tower annually.

Photovoltaic (PV) panel(s)—31 at the top of each tower may generate 30-300 W, such as 60-200 W, such as about 115 W (pgen) to power avionics, rotate the auger, slewing ring, and tower, and perform auxiliary functions resulting in about 0.6-1 Wh/g H2O extracted, such about 0.8 Wh/g H2O extracted, with an estimated additional 1.5-2 Wh/g H2O extracted, such as about 1.7 Wh/g H2O of power required by the rover.

TABLE 1
Argo's basic system compares favorably to alternatives

| | Generated Power | Concentrated |
|---|---|---|
| System Metrics Comparison - | Required per | Sunlight |
| Water Extraction Only | Gram H₂O | per Gram H₂O |
| Argo Water Extraction (H₂O ice | 0.8 Wh/g | 57 Wh/g |
| concentration in regolith 0.1%) | | (“free” power) |
| Commercial Lunar Propellant | 1.5 Wh/g | N/A |
| Architecture, FIG. 17 & table 1 | | |
| (H₂O ice concentration in | | |
| regolith 4%) | | |
| Planetary Volatiles Extractor | 27 Wh/g | N/A |
| ‘PVEx’ (H₂O ice concentration | | |
| in regolith 5%) | | |

Additionally, FIG. 5 shows how the combination of concentrated solar heating and recycling of heated regolith can result in significant reductions in the electrical power demand to sublimated water from regolith.

### ASPECTS

Various aspects of the present application include:

1. A water extraction system comprising:
a base; and
an extraction system, the extraction system comprising:
   a heated chamber, the heated chamber comprising an outer annulus and an inner core;
   a solar reflector;
   an auger contained within the outer annulus; and
   a water vapor collection system,
wherein the system is configured for feeding regolith from an input bin to an inlet of the heated chamber,
wherein the auger is configured to move the regolith along the outer annulus of the heated chamber to a top part of the heated chamber and recycle heated regolith to the inner core,
wherein the solar reflector is configured to heat the heated chamber using concentrated solar energy,
wherein the heated chamber is configured to liberate water vapor from the regolith, by a combination of the solar energy from the solar reflector and recycled heat from heated regolith,
wherein the water vapor collection system is configured to collect the water vapor.

2. The water extraction system of aspect 1, wherein the system is configured to extract water from regolith containing less than 2% water, such as less than 0.5% water.

3. The water extraction system of any of aspects 1 to 2, wherein the system is configured, for each kg of landed system mass, produce over 4 kg, such as over 8 kg, such as over 15 kg of water per year.

4. The water extraction system of any of aspects 1 to 3, wherein the base is configured to rotate the extraction system to track the sun.

5. The water extraction system of any of aspects 1 to 4, wherein the base is configured to rotate the extraction system up to 360°.

6. The water extraction system of any of aspects 1 to 5, wherein the extraction system further comprises an inlet port and an outlet port, wherein the inlet port is configured for feeding regolith from the input bin to the inlet of the heated chamber, wherein the outlet port is configured for feeding regolith to an output bin.

7. The water extraction system of aspect 6, wherein the extraction system is sealed with vacuum seals at the inlet and outlet ports, and at the interfaces to the water collection chambers

8. The water extraction system of any of aspects 1 to 7, wherein the extraction system is configured for batch operation.

9. The water extraction system of any of aspects 1 to 8, wherein the extraction system is configured to allow for continuous operation.

10. The water extraction system of any of aspects 1 to 9, wherein the system further comprises a PV solar panel.

11. The water extraction system of any of aspects 1 to 10, wherein the system further comprises a valve to release heated regolith through an outlet port.

12. The water extraction system of any of aspects 1 to 11, wherein the system further comprises an output bin.

13. The water extraction system of any of aspects 1 to 12, wherein the system is at a 1-10° tilt normal to a low polar sun altitude near the lunar poles.

14. The water extraction system of any of aspects 1 to 13, wherein the input bin is configured to be slewed above the inlet port of the heated chamber.

15. The water extraction system of any of aspects 1 to 14, wherein the heated chamber is only heated by the solar reflector.

16. The water extraction system of any of aspects 1 to 15, wherein the solar reflector provides concentrated solar energy to the heated chamber.

17. The water extraction system of any of aspects 1 to 16, wherein the solar reflector is a parabolic reflector.

18. The water extraction system of any of aspects 1 to 17, wherein the solar reflector is compactable for lunar delivery and thermal insulation and expandible or deployable for operation.

19. The water extraction system of any of aspects 1 to 18, wherein the solar reflector comprises a dust rejection mechanism.

20. The water extraction system of any of aspects 1 to 19, wherein the auger transports regolith vertically through the extractor while the regolith is being heated.

21. The water extraction system of any of aspects 1 to 20, wherein the water vapor collection system comprises a cold trap.

22. The water extraction system of any of aspects 1 to 21, wherein the water vapor collection system comprises a cold trap and a H2O storage chamber.

23. The water extraction system of any of aspects 1 to 22, wherein the system comprises a heating method to melt frozen H2O in the cold trap to produce water for extraction.

24. The water extraction system of any of aspects 1 to 23, wherein the H2O storage chamber is removeable for transport of the H2O for other purposes.

25. The water extraction system of any of aspects 1 to 24, wherein the H2O storage chamber comprises a fluid transfer port for removal of extracted H2O.

26. The water extraction system of any of aspects 1 to 25, wherein the heating method for the cold trap is a portion of the solar reflecting mirror.

27. The water extraction system of any of aspects 1 to 26, wherein the heated regolith is retained inside the system over a lunar night for thermal energy.

28. The water extraction system of any of aspects 1 to 27, wherein the deployed solar reflector is configured to fold to provide thermal insulation to the system and its systems for thermal protection over a lunar night.

29. A method for extracting H2O from regolith in a water extraction system, the method comprising:
feeding regolith from an input bin to an inlet of a heated chamber, the heated chamber comprising an outer annulus and an inner core,
heating the heated chamber with concentrated solar energy from a solar reflector,
moving the regolith through the outer annulus, wherein the regolith is heated such that water vapor is liberated from the regolith,
recycling the heated regolith to the inner core of the heated chamber, wherein the heated regolith transfers heat to regolith in the outer annulus,
collecting the liberated water vapor in a water vapor collection system.

30. The method of aspect 29, wherein the fed regolith contains less than 2% water, such as less than 0.5% water.

31. The method of any of aspects 29 to 30, the method further comprising providing regolith to the input bin from an autonomous rover.

32. The method of any of aspects 29 to 31, the method further comprising providing regolith to the input bin and slewing the input bin to be primarily above the inlet of the heated chamber to allow for a gravity feed to the inlet.

33. The method of any of aspects 29 to 32, wherein the system is sealed with vacuum seals at interfaces of the input and output bins, and at interfaces of the water collection chambers.

34. The method of any of aspects 29 to 33, the method further comprising collecting regolith in an output bin.

35. The method of any of aspects 29 to 34, the method comprising holding the heated regolith in the inner core until input bin is empty.

36. The method of any of aspects 29 to 35, the method comprising releasing dried regolith from the inner core as its temperature reaches a certain value as determined by a temperature sensor.

37. The method of any of aspects 29 to 36, the method further comprising rotating a base of the water extraction system.

38. The method of aspect 37, the method further comprising rotating the base to track the sun.

39. The method of aspect 37, the method further comprising rotating the base about 360°.

40. The method of any of aspects 29 to 39, wherein moving the regolith vertically comprises moving by a rotating auger.

41. The method of any of aspects 29 to 40, the method further comprising operating the system with a PV solar panel.

42. The method of any of aspects 29 to 41 the method further comprising slewing the input bin above the inlet of the heated chamber.

43. The method of any of aspects 29 to 42, the method further comprising opening a valve to release heated regolith from the inner core.

44. The method of any of aspects 29 to 43, where the heated chamber is only heated by the solar reflector.

45. The method of any of aspects 29 to 44, the method further comprising collecting the liberated water vapor in a cold trap.

46. The method of aspect 45, the method further comprising heating the cold trap to melt frozen H2O in the cold trap to produce water for extraction.

47. The method of any of aspects 29 to 46, the method further comprising retaining the heated regolith inside the water extraction system over a lunar night to provide thermal energy to the water extraction system.

Various examples and embodiments of the inventive subject matter disclosed here are possible and will be apparent to a person of ordinary skill in the art, given the benefit of this disclosure. In this disclosure reference to “embodiments” means that those embodiments are non-limiting examples of the inventive subject matter, and there may be alternative embodiments which are not excluded.

The articles “a,” “an,” and “the” are used herein to refer to one or more than one (i.e., to at least one) of the grammatical object of the article. By way of example, “an element” means one element or more than one element.

As used herein, the term “about” means ±10% of the noted value. By way of example only, a composition comprising “about 30 wt. %” of a component could include from 27 wt. % of the component up to and including 33 wt. % of the component.

Also herein, the recitations of numerical ranges by endpoints include all numbers subsumed within that range (e.g., 1 to 5 includes 1, 1.5, 2, 2.75, 3, 3.80, 4, 5, etc.).

The word “comprising” is used in a manner consistent with its open-ended meaning, that is, to mean that a given product or process can optionally also have additional features or elements beyond those expressly described. It is understood that wherever embodiments are described herein with open-ended meaning, otherwise analogous embodiments described in terms of “consisting of” and/or “consisting essentially of” are also contemplated and within the scope of this disclosure.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

The different aspects, alternatives and embodiments of the invention disclosed herein can be combined with one or more of the other aspects, alternatives and embodiments described herein. Two or more aspects can be combined.

While the embodiments of the present disclosure have been described with particular reference to certain embodiments thereof, it will be understood that changes and modifications may be made by those of ordinary skill within the scope and spirit of the following claims.

1. A water extraction system comprising:
a base; and
an extraction system, the extraction system comprising:
a heated chamber, the heated chamber comprising an outer annulus and an inner core;
a solar reflector;
an auger contained within the outer annulus; and
a water vapor collection system,
wherein the system is configured for feeding regolith from an input bin to an inlet of the heated chamber,
wherein the auger is configured to move the regolith along the outer annulus of the heated chamber to a top part of the heated chamber and recycle heated regolith to the inner core,
wherein the solar reflector is configured to heat the heated chamber using concentrated solar energy,
wherein the heated chamber is configured to liberate water vapor from the regolith, by a combination of the solar energy from the solar reflector and recycled heat from heated regolith,
wherein the water vapor collection system is configured to collect the water vapor.

2. The water extraction system of claim 1, wherein the system is configured to extract water from regolith containing less than 2% water.

3. The water extraction system of claim 1, wherein the base is configured to rotate the extraction system to track the sun.

4. The water extraction system of claim 1, wherein the extraction system further comprises an inlet port and an outlet port, wherein the inlet port is configured for feeding regolith from the input bin to the inlet of the heated chamber, wherein the outlet port is configured for feeding regolith to an output bin.

5. The water extraction system of claim 1, wherein the extraction system is configured for batch operation.

6. The water extraction system of claim 1, wherein the extraction system is configured to allow for continuous operation.

7. The water extraction system of claim 1, wherein the system further comprises a valve to release heated regolith through an outlet port.

8. The water extraction system of claim 1, wherein the system is at a 1-10° tilt normal to a low polar sun altitude near the lunar poles.

9. The water extraction system of claim 1, wherein the input bin is configured to be slewed above the inlet port of the heated chamber.

10. The water extraction system of claim 1, wherein the heated chamber is only heated by the solar reflector.

11. The water extraction system of claim 1, wherein the solar reflector is compactable for lunar delivery and thermal insulation and expandible or deployable for operation.

12. The water extraction system of claim 1, wherein the auger transports regolith vertically through the extractor while the regolith is being heated.

13. The water extraction system of claim 1, wherein the water vapor collection system comprises a cold trap.

14. The water extraction system of claim 1, wherein the water vapor collection system comprises a cold trap and a H2O storage chamber.

15. The water extraction system of claim 1, wherein the system comprises a heating method to melt frozen H2O in the cold trap to produce water for extraction.

16. The water extraction system of claim 1, wherein the H2O storage chamber is removeable for transport of the H2O for other purposes.

17. The water extraction system of claim 1, wherein the H2O storage chamber comprises a fluid transfer port for removal of extracted H2O.

18. The water extraction system of claim 1, wherein the heating method for the cold trap is a portion of the solar reflecting mirror.

19. The water extraction system of claim 1, wherein the deployed solar reflector is configured to fold to provide thermal insulation to the system and its systems for thermal protection over a lunar night.

20. A method for extracting H2O from regolith in a water extraction system, the method comprising:
feeding regolith from an input bin to an inlet of a heated chamber, the heated chamber comprising an outer annulus and an inner core,
heating the heated chamber with concentrated solar energy from a solar reflector,
moving the regolith through the outer annulus, wherein the regolith is heated such that water vapor is liberated from the regolith,
recycling the heated regolith to the inner core of the heated chamber, wherein the heated regolith transfers heat to regolith in the outer annulus,
collecting the liberated water vapor in a water vapor collection system.

21. The method of claim 20, wherein the fed regolith contains less than 2% water, such as less than 0.5% water.

22. The method of claim 20, the method comprising releasing dried regolith from the inner core as its temperature reaches a certain value as determined by a temperature sensor.

23. The method of claim 20, the method further comprising rotating a base of the water extraction system.

24. The method of claim 23, the method further comprising rotating the base to track the sun.

25. The method of claim 20, wherein moving the regolith vertically comprises moving by a rotating auger.

26. The method of claim 20, the method further comprising opening a valve to release heated regolith from the inner core.

27. The method of claim 20, where the heated chamber is only heated by the solar reflector.

28. The method of claim 20, the method further comprising collecting the liberated water vapor in a cold trap.

29. The method of claim 28, the method further comprising heating the cold trap to melt frozen H2O in the cold trap to produce water for extraction.
